(19) United States
(12) Patent Application Publication
(10) Pub. No.: US 2007/0194085 A1
(43) Pub. Date: Aug. 23, 2007

(54) HIGH VELOCITY METALLIC POWDER SPRAY FASTENING

(76) Inventors: Donald J. Spinella, Greensburg, PA (US); Sherri F. McCleary, Apollo, PA (US)

Correspondence Address: Harry A. Hild, Jr.;Alcoa Technical Center, Intellectual Property, Building C, 100 Technical Drive, Alcoa Center, PA, 15069-0001, US

(21) Appl. No.: 11/621,456

(22) Filed: Jan. 9, 2007

Related U.S. Application Data
(60) Provisional application No. 60/757,354, filed on Jan. 9, 2006.

(51) Int. Cl. A47J 36/02

(52) U.S. Cl. 228/101

(57) ABSTRACT

The present invention provides a low temperature joining method that is compatible with multiple materials and results in a bond between joined structures without reducing the mechanical properties of the joined structures base materials. The method of the present invention includes the steps of contacting a first structure to a second structure; and directing particles of a metallic bonding material towards an interface between the first structure and second structure at a velocity to cause the particles of the metallic bonding material form a molecular fusion between the first structure and second structure.

### CROSS REFERENCE TO RELATED APPLICATIONS

The present invention claims the benefit of U.S. provisional patent application 60/757,354 filed Jan. 9, 2006, the whole contents and disclosure of which is incorporated by reference as is fully set forth herein.

### FIELD OF THE INVENTION

The present invention relates generally to the field of materials technology, and in one embodiment to structural joints and bonding methods utilizing high velocity powder spray apparatuses and metallic powders.

### BACKGROUND OF THE INVENTION

Welding technologies, such as gas tungsten arc welding (TIG), gas metal arc welding (MIG), plasma-welding, and laser-welding, present a number of issues when joining multiple structures from a single side. Welding typically requires that the welded metals consist of the same alloy and is typically not suitable for bi-metallic junctions, such as junctions between iron and aluminum. Another disadvantage of welding technologies is an inability to weld metals with different classifications of materials, such as glass and ceramics, to produce bi-material junctions.

Welding is also limited in applications in which adhesives are employed. For example, the existence of welding lubricants have a detrimental effect on adhesive integrity, and specialized gas shields are often required to protect adhesives when employed in combination with MIG and TIG welding processes. Additionally, welding processes that produce arcs and lasers must be shielded from accidental contact by workers handling the welding apparatuses. Welding processes further require time and intensive surface preparation to ensure weld consistency and is not suitable for painted, primed, and anodized surfaces.

Welding also typically results in the formation of a heat effected zone within close proximity to the welded joint, at which the mechanical and corrosion properties of the base metals are substantially reduced. For example, the heat effected zone typically has decreased tensile strength, elongation, and hardness when compared to the base metal of the structures being joined, which are not subjected to the heat effect.

Other joining technologies, such as resistance spot welding, self-piercing riveting, and clinching require access to the back face of the joined structures, which is opposite the face of the structures at which the process is actuated.

### SUMMARY OF THE INVENTION

Generally, in one aspect of the invention, a bonding method is provided including at least the steps of:
contacting a first structure to at least a second structure; and
directing particles of a metallic bonding material towards an interface between said first structure and said at least said second structure at a velocity with sufficient energy for said particles of said metallic bonding material to form a bond between said first structure and said second structure.

In one embodiment, the term “velocity with sufficient energy” means that the particle velocity in combination with particle diameter and particle density of the metallic bonding material is selected to clean the joining surfaces to be devoid of any surface contamination, including but not limited to oxides, lubricants, adhesives, inorganic coatings, and organic coatings, wherein the metallic bonding material adheres to at least the clean surfaces of the first and second structures to effectuate a joint. In one embodiment, a velocity with sufficient energy may be provided by a metallic bonding material having a particle diameter ranging from about 1 to about 50 microns, a particle density ranging from about 2.5 g/cm³ to about 20 g/cm³, and being propelled at a velocity of 450 m/s to 1500 m/s. The metallic bonding material may be any metal including but not limited to Al, Ag, Au, Cu and Zn.

In one embodiment, the means for directing particles of the metallic bonding material is provided by a cold spray apparatus. In one embodiment, the bond provided is a solid state bond. A solid state bond is a joint, also referred to as a weld, that is provided at a temperature below the melting point of the materials being joined.

In another aspect of the present invention, a joint structure is provided by the above method in which the mechanical structures of the base materials are not subjected to a decrease in mechanical properties, which is typically present in joints formed using prior art welding processes. In one embodiment, the inventive joint structure includes:
a first structure; and
at least a second structure in contact with a portion of said first structure; and
a molecular fusion at an interface between said first structure and said at least said second structure with a metallic bonding material.

The term “molecular fusion” denotes a bond between the metallic bonding material and the joined structures that does not exhibit substantial changes in at least the joined structure's metallurgical chemistry, such as intermixing, at the interface between the metallic bonding material and the joined structures. No substantial change in the metallic chemistry of the joined structures means that the metallic chemistry of the structures prior to the formation of the joint is the same as the metallurgical chemistry of the structures following the joint. Hence, each of structures being joined have metallurgical properties at the interface of the joint resulting from the metallurgical composition of that structure without any degradation resulting from intermixing of the compositions of the materials being joined. Further, in one embodiment, since the temperature at which the molecular fusion is formed is less than the melting temperature of the structures being joined, and the temperature at which the molecular fusion is formed may be less than the heat treatments to the joined structures, the present joint structure does not exhibit a heat effected zone, as experienced in prior joining methods, such as welding.

In one embodiment, the molecular fusion results in a joint in which the mechanical properties of the structures being joined are substantially uniform, wherein in one embodiment the mechanical properties of the structure measured at the interface of the structure to the joint are equal to the mechanical properties of the structure distal from the joint. The mechanical properties may include elongation, tensile strength and micro-hardness. In one example, the microhardness of the structures at the interface of the joint provided by the molecular fusion may be measured using Vickers hardness testing, wherein the microharness of the structure at the interface would be equal to microhardness measurements of the structure distal from the interface, wherein the microhardness may be uniform throughout the entire structure.

### BRIEF DESCRIPTION OF THE DRAWINGS

FIG. 1 depicts a schematic representation of a high velocity powder spray apparatus.

FIGS. 2a-2d (cross-sectional side view) depict one embodiment of the bonding method of the present invention.

FIG. 3a (cross-sectional side view) depicts a prior art weld and a corresponding plot of the mechanical properties along the length of the weld.

FIG. 3b (cross-sectional side view) depicts a joint structure formed in accordance with the inventive joining method and a corresponding plot of the mechanical properties along the length of the joint structure.

FIGS. 4a-4b (top view) depict examples of hole geometries that may be employed in the inventive bonding method.

FIGS. 5-6 (cross-sectional side view) depict embodiments of the inventive joint structure between three separate structures.

FIG. 7 (cross-sectional side view) depicts one embodiment of a splice butt joint formed utilizing the bonding method of the present invention.

FIG. 8 (cross-sectional side view) depicts one embodiment of a lap tee joint formed utilizing the bonding method of the present invention.

FIGS. 9a-9d (cross-sectional side view) depict embodiments of the present invention in which structural components are joined with flat sheets.

FIG. 10a (prospective view) and FIG. 10b (cross-sectional side view) depict another embodiment of a structural component being bonded to a second structure utilizing the bonding method of the present invention.

FIG. 11 (top view) depict embodiments of lap joints formed utilizing the bonding method of the present invention.

FIG. 12 (cross-sectional side view) depicts one embodiment of a hem joint formed utilizing the inventive bonding method.

FIG. 13 (cross-sectional side view) depicts one embodiment of a butt joint with lap fillet tack bonds formed utilizing the inventive bonding method.

FIG. 14a (prospective view) and FIG. 14b (cross-sectional side view) depict a joint to a space frame formed utilizing the inventive bonding method.

### DETAILED DESCRIPTION OF THE PREFERRED EMBODIMENTS

In one embodiment, the present invention provides a low temperature joining method that is compatible with multiple material types and results in a molecular fusion between joined structures without reducing the mechanical properties of the joined structure's base materials.

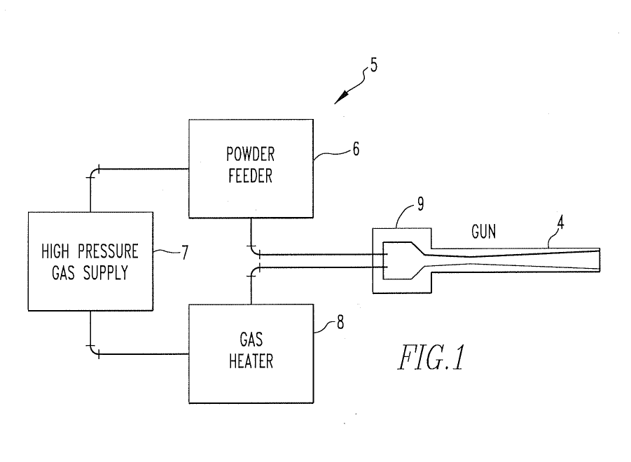

Referring to FIG. 1, in one embodiment, the present invention employs a high velocity powder spray apparatus 5 to deposit metallic bonding material to interlock two of more structures. One example of a high velocity powder spray apparatus 5 may comprise a powder feeder 6, high pressure gas supply 7, a gas heater 8, and a gun 9 to direct the metallic bonding material to the surfaces of the structures to be joined at a sufficient velocity to form a molecular fusion between the surfaces being joined and the metallic bonding material. In one embodiment, the molecular fusion is provided without bringing the structures to be joined to their melting temperatures, hence providing a bond without resulting in a heat effected zone. The heat effected zone is present in joining techniques that increase the temperature of the structures to be joined to about the melting temperature or greater, wherein the increased temperatures result in intermixing of the material of the structures being joined, disadvantageously resulting in decreased mechanical properties at the interface of the joint.

In one embodiment, cold spray is used to spray a metallic powder at sufficient velocities to produce a bond consistent with the present invention. Cold spray may also be referred to as gas dynamic spray, supersonic spray, and/or kinetic spray. In one embodiment, the cold spray process uses the energy stored in high pressure compressed gas to propel fine metallic powder particles (also referred to as metallic bonding material) at velocities ranging from approximately 450 m/s to approximately 1500 m/s. In one embodiment, the metallic bonding material may be propelled in the range of approximately 500 m/s to approximately 600 m/s. In one embodiment, compressed gas, such as helium, is fed via a heating unit 8 (also referred to as gas heater) to the gun 9 where the gas exits through a nozzle 4 to produce a high velocity gas jet. Compressed gas is also fed via a high pressure powder feeder 6 to introduce metallic powder into the high velocity gas jet. In one embodiment, the particles of the metallic bonding material are accelerated to a velocity and temperature where on impact with a substrate they deform and bond. In one embodiment, the metallic bonding material may have a particle diameter ranging from about 1 to about 50 microns, a particle density ranging from about 2.5 g/cm³ to about 20 g/cm³, and may be propelled at a velocity of 450 m/s to 1500 m/s. The metallic bonding material may be any metal including but not limited to Al, Ag, Au, Cu and Zn. It is noted that other metallic bonding materials, particle sizes, and particle densities have been contemplated, and are within the scope of the invention, so long as the combination of velocity, particle size, composition, and density does not raise the temperature of the structures being joined to the structure's melting temperature.

In one embodiment, the velocity of metallic powder contacting the surfaces of the structures to be joined is sufficiently high to clean the surfaces being joined of surface contamination, and to adhere to at least the interface of the structures being joined. The velocity of the metallic powder may be sufficiently high to remove surface contaminates from the metallic powder and at least the interface between the first and second structure providing clean bonding surfaces.

The particles remain in the solid state and are relatively cold, so the bulk reaction on impact is substantially in the solid state only. In one embodiment, the low temperature of the process also aids in retaining the original powder chemistry of the metallic bonding material and mechanical properties of the base materials in the structures to be joined. In one embodiment, the temperature of the process is below the lowest melting temperature of the structures being joined. In another embodiment, the temperature of the particles of the metallic bonding material contacting the bonding surfaces ranges from approximately 50° C. to approximately 300° C.

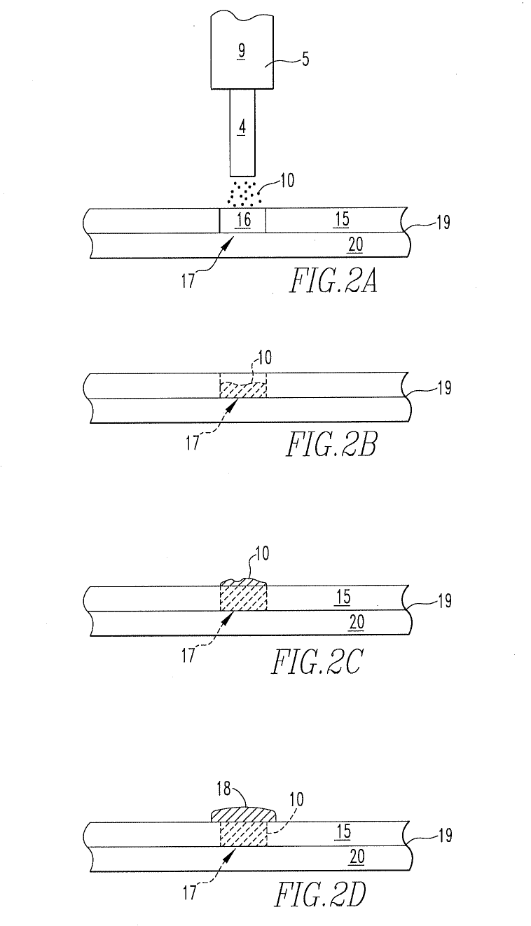

Referring to FIGS. 2a-2d, in one embodiment of the bonding method, a high velocity powder spray apparatus 5, such as a cold spray apparatus, directs particles of a metallic bonding material 10 towards an interface between the first structure 15 and the second structure 20 to be joined. The interface between the first structure 15 and the second structure 20 may include the exposed surfaces at which the first structure 15 and the second structure 20 are in contact. Although each of the Figures depict only two structures being joined, it is noted that the present disclosure is equally applicable to joining any number of structures.

Referring to FIG. 2a, the interface may be provided by forming a hole 16 through the first structure 15 and positioning the first structure 15 on the second structure 20. In this embodiment, the interface comprises the sidewalls of the hole 16 and the portion of the second structure's surface 17 exposed through the hole 16. The nozzle 4 of the high velocity powder spray apparatus 5 is then aligned to the hole 16 and sprays particles of metallic bonding material 10 at a sufficient velocity to produce a molecular fusion between the structures to be joined and the metallic bonding material at the interface. As particle spray continues the metallic bonding material 10 accumulates within the hole 16, as depicted in FIG. 2b, until extending from the hole 16 beyond the plane of the first structure's 15 upper surface, as depicted in FIG. 2c. Referring to FIG. 2d, particle spray preferably continues until the metallic bonding material 10 forms a cap 18 extending overlying a portion of the first structure's 15 upper surface, wherein the cap 18 portion has a diameter greater than the hole 16.

In one embodiment, the first and second structures 15, 20 being joined may comprise a metal, ceramic, or glass. In one embodiment, the first and second structure 15, 20 may comprise the same or different materials. Examples of metals which may be joined using the inventive method include, but are not limited too: aluminum, steel, iron, and magnesium. The first and second structures 15, 20 may also be painted or coated without affecting the quality of the bond, since the energy at which the particles of the metallic bonding material are propelled prepares the bonding surfaces and removes surface contaminates. Some examples of surface contaminates that may be removed by the particle spray include but are not limited too: oxides, lubricants, adhesives, inorganic coatings, organic coatings and combinations thereof.

An adhesive material 19 may be positioned between the first structure 15 and the second structure 20, wherein the adhesive material 19 may comprise structure adhesives, acrylics, epoxies, urethanes, sealants, tape adhesives or combinations thereof. It is noted that the adhesive material 19 is optional.

In one embodiment, the metallic bonding material 10 comprises a metallic powder that may comprise, but is not limited to, aluminum, silver, copper, zinc, gold, or combinations and alloys thereof. In one embodiment, the particle size of the metallic powder may range from approximately 1.0 micron to approximately 50.0 microns. In one embodiment, the particle density ranges from about 2.5 g/cm³ to about 20 g/cm³. In one embodiment, the metallic bonding material may be Al having a density of about 2.7 g/cm³, Zn having a density of about 7.1 gm/cm³, Ag having a density of about 10.5 g/cm³, Cu having a density of 8.96 g/cm³, Au having a density of 19.32 g/cm³, or a combination thereof.

Another aspect of the present invention is a joint structure formed from the inventive bonding method. Joint structures produce by the inventive method are advantageously free of a heat effected zone that is typically present in joint structures formed using prior welding processes. In prior welding processes the heat generated at the welding surface disadvantageously reduces the mechanical properties of the base material of the structure being welded. For example, the temperature in close proximity to the weld may be greater than the metallic base material's heat treatment, therefore reducing the mechanical properties of the base material in that region, such as elongation, tensile strength and micro-hardness. Therefore, the mechanical properties of the base material in close proximity welded joints are not uniform. The present invention utilizes a low temperature process that provides a metallurgical bond with metallic structures without decreasing the base material's mechanical properties at the region adjacent to the joint, therefore resulting in a joint structure in which the mechanical properties of the joined structure's base material is substantially uniform.

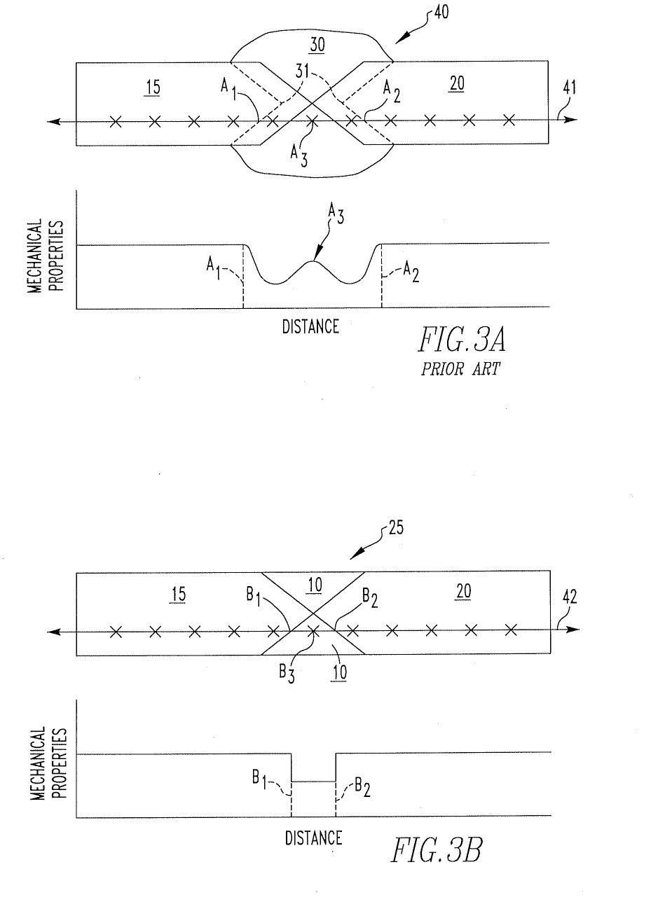

FIG. 3a depicts a welded joint 40 between a first structure 15 and a second structure 20, in which the mechanical properties along reference line 41 is plotted along the weld joint's length to demonstrate the effect of the heat effected region 31 on the mechanical properties of the first and second structures 15, 20 base material. Specifically, the mechanical properties along reference line 41 are substantially uniform until reaching reference points A1 and A2, wherein a substantial drop in mechanical properties occurs within the metallic base material due to the heat effect zone 31 resulting from the formation of the weld 30. The drop in mechanical properties typically results from the intermixing of the first and second structure 15, 20 composition with the weld 15 composition at the bond interface. The slight rise in mechanical properties at A3 is due to the weld 30 material, and is not an effect resulting from intermixing with the first and or second structures 15, 20, wherein the rise in mechanical properties may or may not be present. The decrease in mechanical properties may include micro-hardness, tensile strength, and/or elongation.

FIG. 3b depicts one embodiment of a joint structure 25 including a molecular fusion of the metallic bonding material 10, the first structure 15 and the second structure 20, in which the mechanical properties along reference line 42 is plotted along the joint structure's 25 length to demonstrate the uniformity in mechanical properties along the entirety of the first and second structure's 15, 20 base materials. Specifically, the mechanical properties along reference line 42 are substantially uniform until reaching reference points B1 and B2 illustrating substantial uniformity in mechanical properties along the entire length of the first and second structure's base materials 15, 20. Reference points B1 and B2 correspond to the transition between the base material of the structure to be welded and the metallic bonding material 10 that provides the molecular fusion. Therefore, the drop in mechanical properties present in the portion of the plot corresponding to points B1 and B2 is due to the mechanical properties of the metallic bonding material 10, which is independent from the mechanical properties of the base materials in the first and second structure 15, 20. The uniformity in mechanical properties may be observed in micro-hardness, tensile strength, and/or elongation.

FIG. 2a-2d and FIGS. 4a to 14b illustrate embodiments of joint structures that may be formed using the bonding method of the present invention. It is further noted that the following embodiments are provided for illustrative purposes and are not intended to limit the scope of the present invention. It is further noted that the bonding method of the present invention is suitable for any joint structure geometry, so long as the geometry allows for the metallic bonding material to be sprayed in a manner that provides a molecular fusion between the structures to be joined. Additionally, an adhesive may be employed in the joint structures formed in accordance with the inventive bonding method, wherein the adhesive provides connectivity between adjacent surfaces of the structures to be joined.

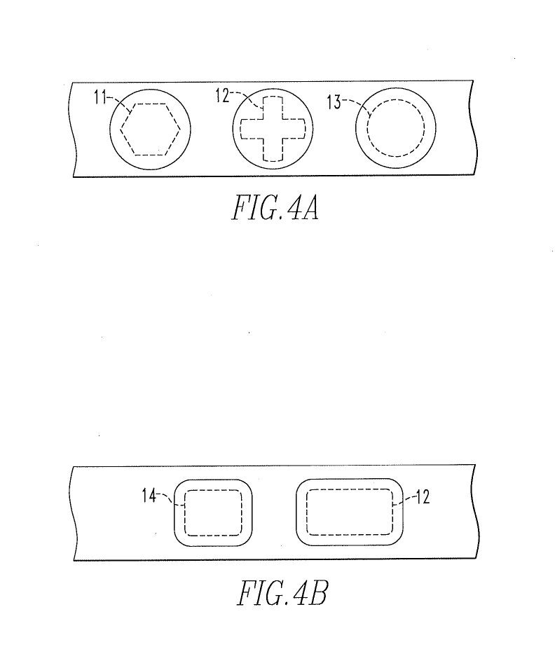

FIGS. 4a and 4b depict embodiments of joint structures produced using the method described with reference to FIGS. 2a-2d. As discussed above, the interface between the first and second 15, 20 structures may be provided by forming a hole 16 through the first structure 15 and positioning the first structure 15 atop the second structure 20. The hole 16 may be punched, machined or drilled through the structure to be joined. Referring to 4a, the hole may have a hexagonal 11, cross 12, or circular 13 cross-section. Referring to FIG. 4b, the hole may have a square 14, or rectangular 21 cross-section. The hexagonal 11, cross 12, rectangular 21 and square 14 cross-sections may be preferred in some applications to prevent joint rotation.

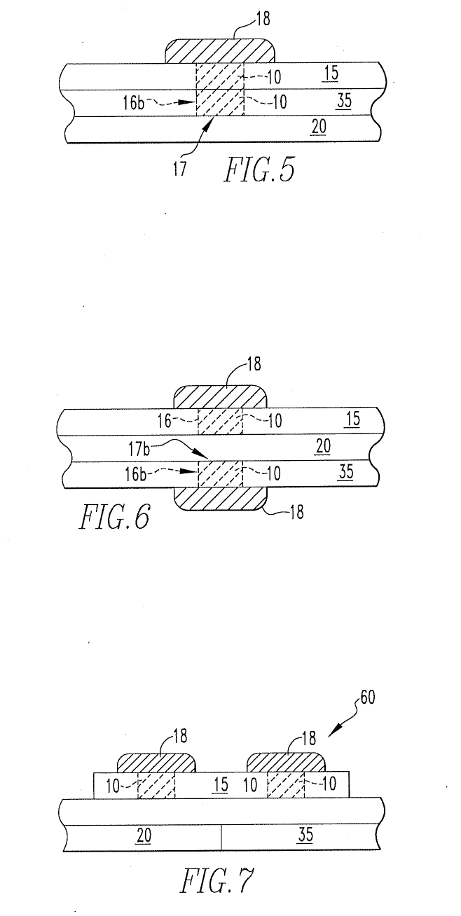

Referring to FIGS. 5, 6 and 7, the bonding method described above with reference to FIGS. 2a-2d may be utilized to join greater than two structures. For example, in one embodiment, a third structure 35 having another hole 16b formed therein may be joined between the first and second structure 15, 20, wherein the interface between the metallic bonding material 10 and the joined structures is the sidewalls of the hole structures 16, 16b through the first and third structure 15, 35 and the exposed face 17 of the second structure 20, as depicted in FIG. 5. Referring to FIG. 6, in another embodiment the third structure 35 may be bonded to an opposite surface 17b of the second structure 20 that the first structure 15 is bonded to. In another embodiment, the inventive bonding method may also be utilized to form a splice butt joint 60, as depicted in FIG. 7. Similar to the first and second structures 15, 20, the third structure 35 may comprise metals, glass or ceramics, and may be the same or a different material than the first and second structures 15, 20. Additionally, the present invention may be practiced to bond any number of structures.

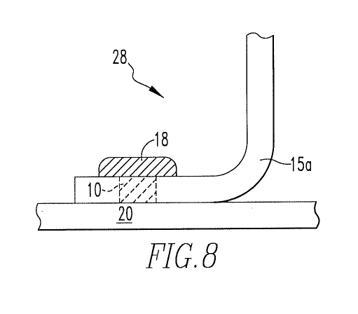

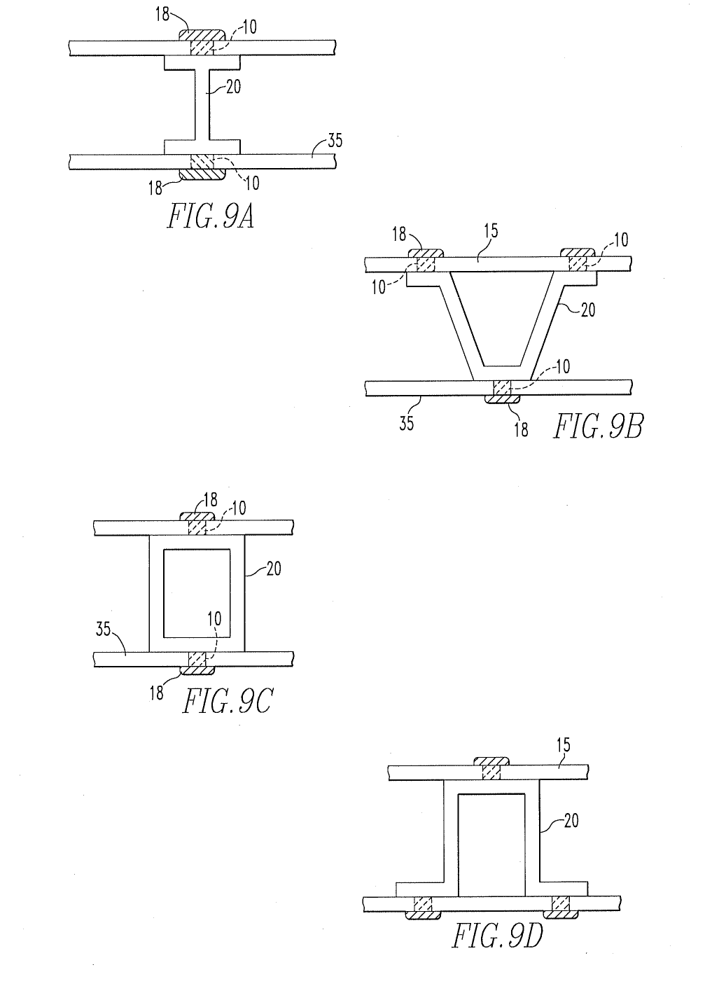

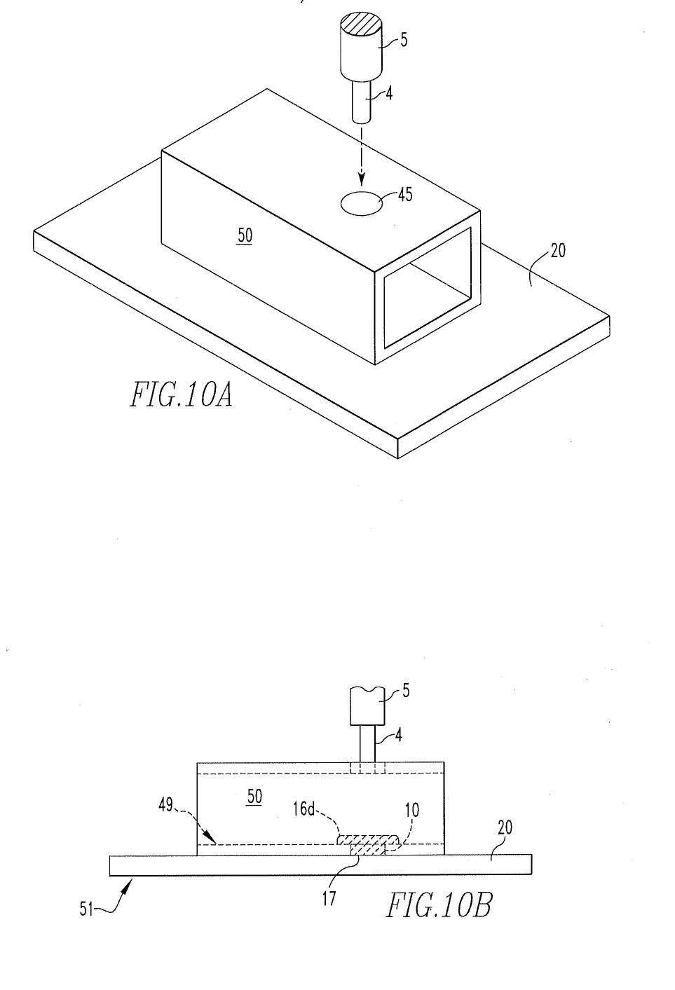

Although the structures 15, 20, 35 depicted in each of the above embodiments is in a flat sheet configuration, it is noted that each joined structure may have any geometry. For example, referring to FIG. 8, a lap tee joint 28 is depicted having a curved structure 15a. Additionally, in further embodiments, the structures 15, 20, 35 may comprise structural component geometries, as depicted in FIGS. 9a-9d and FIGS. 10a-10b.

FIGS. 9a-9d, depict embodiments of structural components 20 joined between two flat sheets 15, 35. In each of these embodiments, a hole 16, 16b, 16c is provided in each sheet 15, 35 to expose a portion of the surface of structural component 20 that is contact with the sheet 15, 35. A bond is formed between each sheet 15, 35 and the structural component 20 by directing particles of the metallic bonding material 10 at a high velocity at the interface between and the exposed surface of the structural component 20 and each sheet 15, 35, wherein a junction is provided by the molecular fusion of the metallic bonding material 10, hole sidewalls in each sheet 15, 35, and exposed surface of the structural component 20. In one embodiment, the continued deposition of the metallic bonding material 10 fills the hole and forms a cap 18 extending from the hole and overlying a portion of the exterior surface of each sheet 15, 35.

Referring to FIGS. 10a and 10b, another embodiment of a joint structure is depicted between a structural component 50 and a flat sheet 20. Although the structural component 50 depicted in FIGS. 10a and 10b is an extrusion, the structural component 50 may be of any geometry, such as a tube or a roll formed section. In one embodiment, an access hole 45 and a joining hole 16d is formed though the structural component 50 sidewalls. The nozzle 4 of the high velocity powder spray apparatus 5 is aligned with the access hole 45 providing an opening though winch particles of the metallic bonding material 10 may be directed towards the interface of the joining hole 16d and the exposed surface of the flat sheet 20, wherein the structural component 50 is joined by the molecular fusion of the metallic bonding material 10, structural component sidewalls, and exposed surface of the flat sheet 17. In this embodiment, the particle spray of the metallic bonding material 1O may be continued until a cap 18 is formed on the inside surface 44 of the structural component 50, allowing for structural components to be bonded to a flat sheet 20 without modifying the exterior surface 51 of the flat sheet 20.

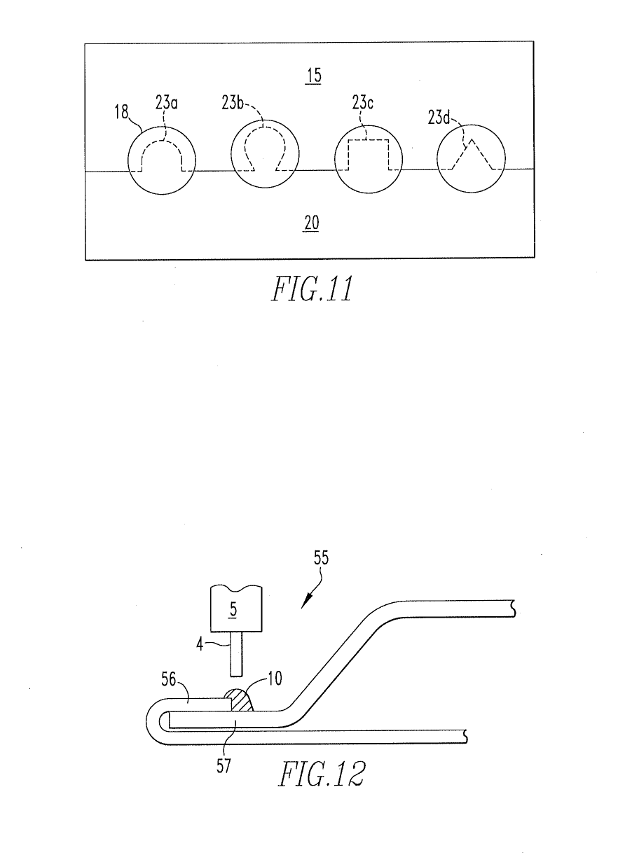

FIG. 1 depicts another embodiment of the present invention, wherein as opposed to forming a hole through the body of one of the structures, an interface for forming an molecular fusion between a first and second structure 15, 20 is provided by nothing 23a, 23b, 23c, 23d an edge portion of the first structure 15 and then positioning the first structure 15 in contact with the second structure 20. In one embodiment, notches 23a, 23b, 23c, 23d may be formed along the edge portion of the structure by conventional machining processes including, but not limited too, punching or drilling. The notch may have any geometry that provides a suitable interface for molecular fusion and is not intended to be limited to the geometries of the notch embodiments depicted in FIG. 11. Following notch process steps, particles of the metallic bonding material 10 may be directed towards the interface of the notched structure 23a, 23b, 23c, 23d and the exposed surface of the underlying structure 20, wherein a molecular fusion of is formed between the deposited metallic bonding material 10, the notch 23a, 23b, 23c, 23d sidewalls, and exposed surface of the underlying structure 20 in contacted with the notched structure 15.

FIG. 12 depicts a means to interlock mechanically hemmed joints 55 utilizing a metallic bonding material 10 being directed by high velocity particle spray 5 to form a molecular fusion at the hemmed portion of the joint. Specifically, a strip of metallic bonding material 10 is formed by directing particles of the metallic bonding material 10 along the length of the hemmed surfaces 56, 57 in accordance with the inventive bonding method, providing both a mechanical and metallic bond between the hemmed members 56, 57. More specifically, a molecular fusion is formed between the deposited metallic bonding material 10, the sidewall of the hemmed structure's overlying portion 56, and an exposed surface of the hemmed structures underlying portion 57 that is in close proximity to the overlying portion. It is noted that this embodiment does not require that a hole or notch be formed through the hemmed surfaces. Although it is preferred that a continuous strip of metallic bonding material 10 is formed along the length of the hemmed surfaces 56, 57, the metallic bonding material 10 may be deposited in a series of discrete tacks along the length of the hemmed surfaces.

FIG. 13 depicts one embodiment of a butt joint 65, wherein a first structure 15 and a second structure 20 are fastened adjacent to one another by a butt strap 66. The first structure 15 and the second structure 20 may have a sheet geometry. The butt strap 66 is bound to the first structure 15 by a first plurality of lap fillet tack bonds 67 and is bound to the second structure 20 by a second plurality of lap fillet tack bonds 68. The first and second plurality of lap fillet tack bonds 67, 68 being formed from metallic bonding material 10 sprayed at a velocity at a sufficient energy to provide a molecular fusion between the butt strap 66 and the first and second structures 15, 20. Although it is preferred that the butt joint 65 is formed using a series of discrete lap fillet tacks 67, 68 of metallic bonding material 10, a continuous strip of metallic bonding material may alternatively be employed as the bonding means.

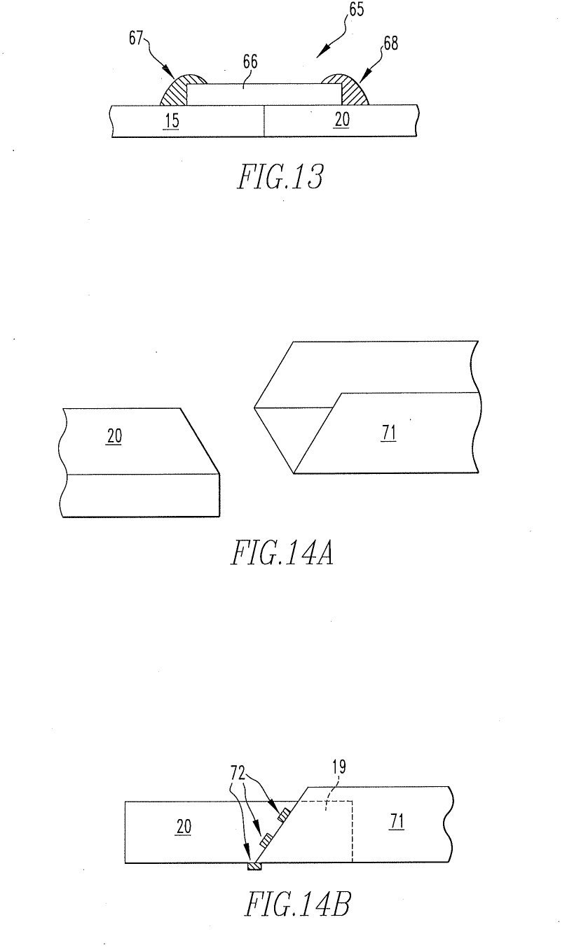

Referring to FIGS. 14a and 14b, in one embodiment, the bonding method and adhesives may be utilized to join automotive space frame components 70, 71. In another embodiment, an adhesive material 19 may be positioned in the overlapping portions of the joined space frame components 70, 71 and a plurality of discrete tacks 72 of metallic bonding material 10 are formed at the interface of the connecting space frame components 70, 71 in a maimer consistent with the inventive method. The tacks of metallic bonding material 10 secure the joined space frame components while the adhesive material 19 sets.

The present invention provides a low temperature bonding method that does not substantially effect the mechanical and corrosion properties of the base materials being joined. The inventive joining method is compatible with a variety of materials (both metallic and nonmetallic) and is compatible with adhesives and painted surfaces. The inventive joining method may be practiced as a low force technology that does not require clamping prior to joining and may further be practiced as a single-sided joining technology that does not require backside support.

While the present invention has been particularly shown and described with respect to preferred embodiments thereof, it will be understood by those skilled in the art that the foregoing and other changes in forms and details may be made without departing from the spirit and scope of the present invention. It is therefore intended that the present invention not be limited to the exact forms and details described and illustrated, but fall within the scope of the appended claims.

What is claimed is:

1. A bonding method comprising:
contacting a first structure to at least a second structure; and
directing particles of a metallic bonding material towards an interface between said first structure and said at least said second structure at a velocity with sufficient energy to for said particles of said metallic bonding material to form a bond between said first structure and said second structure.

2. The bonding method of claim 1, wherein said bond is a molecular fusion resulting from said velocity being sufficient to remove surface contamination from at least said interface between said first structure and said at least said second structure, upon impact of said metallic bonding material with said interface between said first structure and said second structure, wherein said metallic bonding material adheres to said interface.

3. The bonding method of claim 1, wherein said velocity of said metallic bonding material is sufficient to deform said metallic bonding material upon impact with said interface between said first structure and said second structure.

4. The bonding method of claim 2, wherein said surface contamination comprises oxides, lubricants, adhesives, inorganic coatings, organic coatings or combinations thereof.

5. The bonding method of claim 1, wherein said first structure and said at least said second structure may be comprised of metal, ceramics or glass.

6. The bonding method of claim 5, wherein said first structure and said at least said second structure may comprise a same or different material.

7. The bonding method of claim 1, wherein said metallic bonding material comprises aluminum, silver, copper, zinc, gold or combinations thereof, wherein said metallic powder has a diameter on the order of approximately 1.0 micron to approximately 50.0 microns.

8. The bonding method of claim 1, wherein said velocity ranges from approximately 450 m/s to approximately 1500 m/s.

9. The bonding method of claim 1, wherein said metallic bonding material comprises a density ranging from about 2.5 g/cm³ to about 20 g/cm³.

10. The bonding method of claim 1, wherein said contacting said first structure to said at least said second structure further comprises forming at least one hole th-rough said first structure and then positioning said first structure on said at least said second structure, wherein exposed surfaces between said at least one hole in said first structure and said at least said second structure provides said interface.

11. The bonding method of claim 10, wherein directing particles of a metallic bonding material towards said interface continues until said metallic bonding material fills said hole and forms a cap having a width greater than said hole and overlying a portion of said first structure upper surface.

12. The bonding method of claim 11, wherein an adhesive material is positioned between said first structure and said at least said second structure.

13. The bonding method of claim 12, wherein said adhesive material comprises structure adhesives, acrylics, epoxies, urethanes, sealants, or tape adhesives.

14. A joint structure comprising:
a first structure;
at least a second structure in contact with a portion of said first structure; and
a molecular fusion at an interface between said first structure and said at least said second structure with a metallic bonding material, wherein said first structure and said at least said second structure have substantially uniform mechanical properties.

15. The joint structure of claim 14, wherein said metallic bonding material comprises aluminum, silver, copper, zinc, gold or combinations thereof.

16. The joint structure of claim 15, wherein each of said first structure and said at least said second structure comprise a material selected from the group consisting of metals, ceramics, and glass.

17. The joint structure of claim 16, wherein said first structure and said at least said second structure comprise a same or different material.

18. The joint structure of claim 14, wherein said substantially uniform mechanical properties comprises micro-hardness, tensile strength, or elongation.

19. The joint structure of claim 14, wherein said first structure comprises a sheet having at least one hole formed therein, wherein said at least one hole provides said interface between said first structure and said second structure.

20. The joint structure of claim 19, wherein said molecular fusion between said first structure and said at least said second structure fills said at least one hole in said first structure and further comprises a cap portion extending from said at least one hole and having a width greater than a diameter of said at least one hole.

21. The joint structure of claim 14, further comprising an adhesive material where said first structure contacts said second structure.
